(19) United States
(12) Patent Application Publication
(10) Pub. No.: US 2024/0333848 A1
(43) Pub. Date: Oct. 3, 2024

(54) IMAGE PROCESSING APPARATUS, METHOD FOR CONTROLLING IMAGE PROCESSING APPARATUS, AND STORAGE MEDIUM

(71) Applicant: CANON KABUSHIKI KAISHA, Tokyo (JP)

(72) Inventor: YOSHIRO TACHIBANA, Tokyo (JP)

(21) Appl. No.: 18/617,369

(22) Filed: Mar. 26, 2024

(30) Foreign Application Priority Data
Mar. 29, 2023 (JP) 2023-053296
Sep. 29, 2023 (JP) 2023-169331

(51) Int. Cl. H04N 1/00

(52) U.S. Cl. CPC H04N 1/00474; H04N 1/0048; H04N 1/00822

(57) ABSTRACT

An image processing apparatus having a scanning function to scan image data of a document includes a display control unit configured to display a first setting in a predetermined setting area, the first setting being a setting for executing a first function to execute a function related to the scanning function, the function including at least a function to automatically scan both sides of the document, a function to delete blank data contained in the document, and a function to adjust orientation of the image data contained in the document, wherein, in response to the predetermined setting area being selected, the display control unit displays a setting screen including a setting different from the first setting, the setting being for executing a function related to the scanning function.

### BACKGROUND

### Field of the Disclosure

The present disclosure relates to an image processing apparatus, a method for controlling the image processing apparatus, and a storage medium.

### Description of the Related Art

Known image processing apparatuses have a function for generating image data by scanning an image on a document with an image scanning apparatus that scan an image on a document (hereinafter referred to as a scanning function). For the scanning function, there is a demand for improved usability in executing the scanning function with an image processing apparatus while automatically removing only blank pages (blank data), if present, in a plurality of scanned documents.

### SUMMARY

Embodiments of the present disclosure provide an image processing apparatus having a scanning function to scan image data of a document. The image processing apparatus includes a display control unit configured to display a first setting in a predetermined setting area, the first setting being a setting for executing a first function to execute a function related to the scanning function, the function including at least a function to automatically scan both sides of the document, a function to delete blank data contained in the document, and a function to adjust orientation of the image data contained in the document, wherein, in response to the predetermined setting area being selected, the display control unit displays a setting screen including a setting different from the first setting, the setting being for executing a function related to the scanning function.

Further features of the present disclosure will become apparent from the following description of exemplary embodiments with reference to the attached drawings.

### BRIEF DESCRIPTION OF THE DRAWINGS

FIG. 1 is a diagram illustrating the configuration of an image processing system according to an embodiment of the present disclosure.

FIG. 2 is a block diagram illustrating the hardware configuration of the image processing apparatus.

FIGS. 3A to 3D are diagrams illustrating an example of the screen transition of a setting screen displayed on an operating unit when the user toggles a document-orientation detecting function or a blank-page removing function on and off in the image processing apparatus.

FIGS. 4A and 4B are diagrams illustrating an example of the screen transition of a double-sided scan setting screen displayed on the operating unit when the document-orientation detecting function and the blank-page removing function are enabled in the image processing apparatus.

FIGS. 5A and 5B are diagrams illustrating an example of the screen transition of a double-sided scan setting screen displayed on the operating unit when the document-orientation detecting function or the blank-page removing function is disabled in the image processing apparatus.

FIGS. 6A and 6B are diagrams illustrating an example of the screen transition of a transmission standard screen displayed on the operating unit in case where a malfunction occurs in the ADF of the image processing apparatus.

FIGS. 7A and 7B illustrate a flowchart illustrating an example of the procedure of a transmission process in the image processing apparatus.

FIGS. 8A and 8B are diagrams illustrating an example of the screen transition of a platen-glass scan setting screen displayed on the operating unit in case of a malfunction of the ADF and in which the document-orientation detecting function and the blank-page removing function are enabled in the image processing apparatus.

FIGS. 9A and 9B illustrate a flowchart illustrating an example of the procedure of a transmission process in the image processing apparatus.

FIGS. 10A to 10C are diagrams illustrating an example of the screen transition of a setting screen displayed on the operating unit when the user switches ON and OFF of the document-orientation detecting function in the image processing apparatus.

FIGS. 11A and 11B are diagrams illustrating an example of the screen transition of a simple-scan setting screen displayed on the operating unit when the document-orientation detecting function and the blank-page removing function are enabled in the image processing apparatus.

FIGS. 12A and 12B are diagrams illustrating an example of the screen transition of a simple-scan setting screen displayed on the operating unit of the image processing apparatus when the document-orientation detecting function or the blank-page removing function is disabled.

FIGS. 13A and 13B are diagrams illustrating an example of the screen transition of a transmission standard screen displayed on the operating unit in case where a malfunction occurs in the ADF of the image processing apparatus.

### DESCRIPTION OF THE EMBODIMENTS

Embodiments of the present disclosure will be described in detail hereinbelow with reference to the drawings. It is to be understood that the following embodiments do not limit the present disclosure and that not all of the combinations described in the embodiments are required for the solution of the present disclosure.

### First Embodiment

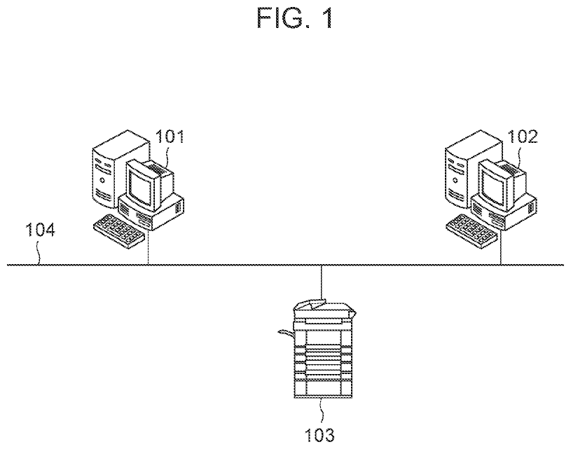

FIG. 1 is a diagram illustrating the overall configuration of an image processing system according to an embodiment of the present disclosure.

The image processing system includes a file-sharing server 101, a mail server 102, and an image processing apparatus 103, such as a multi-function peripheral (MFP), connected via a network 104. The MFP includes, for example, an image scanning apparatus that scans images on a document, a printing function, other functions. The image processing apparatus 103 may be an image scanning apparatus that scans image data on a document, for example, a scanner. The image processing apparatus 103 may be a compound machine having a printing function, in addition to the image scanning apparatus.

The image processing apparatus 103 has a function for storing image data obtained by scanning a document with the image scanning apparatus (scanned data) (scan and save function).

The image processing apparatus 103 further has a function for transmitting the image data to the file-sharing server 101 or the mail server 102 on the network 104 (scan and send function). The image processing apparatus 103 further has a scan and save function, which is a function for scanning and saving the output scanned document data in a storage area. Examples of the storage area in which the scanned data is stored using the scan and save function include an external storage medium, such as a universal serial bus (USB), a storage area (box) in the image processing apparatus 103, and an external service such as a cloud storage.

The image processing apparatus 103 further has a user authentication function so that the administrator of the image processing apparatus 103 can set whether user authentication is required in operating the devices of the image processing apparatus 103.

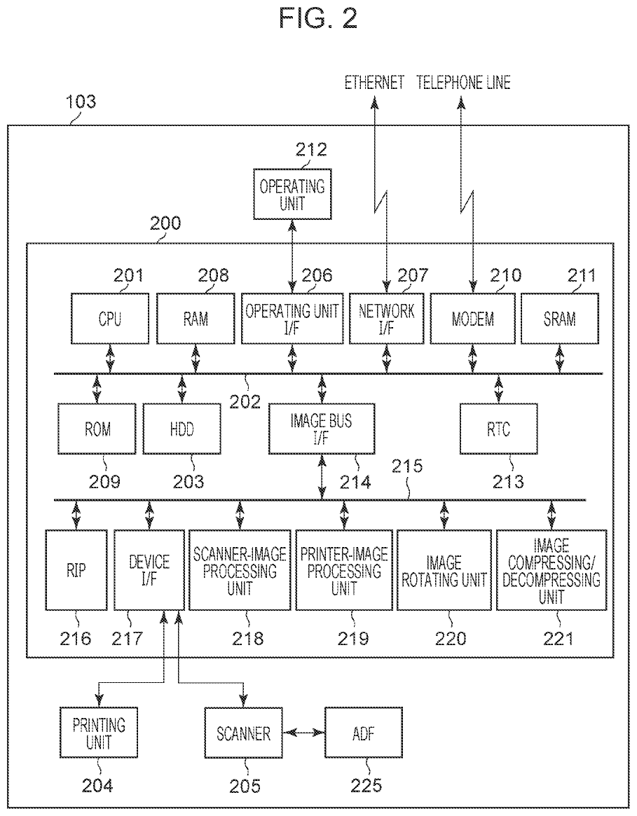

FIG. 2 is a block diagram illustrating the hardware configuration of the image processing apparatus 103 according to an embodiment. The image processing apparatus 103 may store generated image data in an internal storage area. The image processing apparatus 103 may be a scanner that stores the image data in an external memory (for example, a USB flash drive) via an external bus such as a USB. In this embodiment, the image processing apparatus 103 includes the following components by way of example.

A controller unit 200 connects to a scanner 205, which is an image input device, and a printing unit 204, which is an image output device, and to the Ethernet or a telephone line to input and output image data and device information.

The printing unit 204 prints an image based on the input image data on recording paper (sheet). The scanner 205 scans an image on a document that the user sets on a platen glass and stores the obtained image data in a hard disk drive (HDD) 203, a random-access memory (RAM) 208, or the like. An auto document feeder ((ADF) 225 is connected to the scanner 205. The ADF 225 conveys a plurality of documents set in the ADF 225 onto the platen glass in sequence with a conveying unit so that the images on the documents can be scanned by the scanner 205. The image processing apparatus 103 of this embodiment need not necessarily include the ADF 225.

A central processing unit (CPU) 201 is a controller that controls the image processing apparatus 103. The RAM 208 is a system work memory for use in operating the CPU 201 and also serving as an image memory for temporarily storing image data. A read-only memory (ROM) 209 is a boot ROM, in which a system boot program is stored. The HDD 203 stores system software, applications, and image data.

In the image processing apparatus 103 of this embodiment, one CPU 201 executes the processes outlined in the flowcharts, described below, using programs deployed in one memory (RAM 208). This is however illustrative only. For example, the programs outlined in the flowcharts may be executed by a plurality of processors, RAMs, ROMs, and HDDs in cooperation. Some of the processes may be executed using a hardware circuit, such as an application specific integrated circuit (ASIC) or a field programmable gate array (FPGA).

An operating unit (display unit) interface (I/F) 206 is an interface with an operating unit (display unit) 212 including a touch panel and outputs image data to be displayed on the operating unit 212 to the operating unit 212. In other words, the operating unit (display unit) I/F 206 performs a function to transmit information input by the user from the operating unit 212 to the CPU 201. A network I/F 207 connects to a network to input and output information. For example, scanned data is transmitted to an external information processing apparatus via the network I/F 207 using the scan and send function described above. Examples of a communication method used in connection between the apparatuses include IEEE802.11 series communication standard (Wi-Fi) and Bluetooth (Bluetooth Classic, or Bluetooth Low Energy (BLE)). Direct connection need not necessarily be employed between the apparatuses. In a specific example, the apparatuses are connected to a wireless local area network (LAN) router via Wi-Fi, so that the communication between the apparatuses is executed by Internet communication via a wireless LAN router. The apparatuses may communicate with each other using mobile communication (3G, 4G, or 5G).

A modulator-demodulator (MODEM) 210 connects to the telephone line to input and output information.

A static RAM (SRAM) 211 is a high-speed operable non-volatile recording medium. A real-time clock (RTC) 213 continues to count the current time even when the controller unit 200 is powered off. The above devices are disposed on a system bus 202.

An image bus I/F 214 is a bus bridge connecting the system bus 202 and an image bus 215 that transfers image data at high speed and converting the data structure. The image bus 215 is constituted of a peripheral component interconnect (PCI) bus or IEEE1394. The following devices are disposed on the image bus 215.

A raster image processor (RIP) 216 converts a printer description language (PDL) code to a bitmap image. A device I/F 217 connects the scanner 205 and the printing unit 204, which are image input/output devices, to the controller unit 200 to convert image data synchronously or asynchronously. A scanner-image processing unit 218 corrects, processes, and edits input image data. A printer-image processing unit 219 performs correction, conversion of the resolution, and so on of output print image data. An image rotating unit 220 rotates the image data. An image compressing/decompressing unit 221 performs a compressing/decompressing process on the image data.

Functions related to the scanning function include a function to automatically scan image data of both sides of a document by conveying the document with an automatic document feeder (ADF) to capture an image on the document (a duplex document scanning function). Another function is a function to automatically remove (delete) only blank pages (white pages), if present in the document scanned with the scanner, in the image processing apparatus (a blank-page removing function). Another function is a function to rotate (adjust) pages containing image data by performing, for example, optical character recognition (OCR) or image recognition, on the image data and determining the accurate orientations of the image data of the individual pages of the document to calculate the rotation angle (document-orientation detecting function). The accurate orientation of the image data of each page is an orientation in which the upper edge of the image data is “top”, and the lower edge of the image data is “bottom” in the vertical direction. For example, a page in which image data is printed in the vertical direction has the shorter sides of the page oriented in the vertical direction, and a page in which image data is printed in the lateral direction has the longer sides of the page oriented in the vertical direction. The image data may be character data. The duplex document scanning function, the blank-page removing function, and the document-orientation detecting function are enabled by a user operation to enable the functions and disabled by a user operation to disable the functions on a setting screen displayed on the operating (display) unit 212 of the image processing apparatus 103.

However, the settings whether to enable or disable the functions need to be performed by the user. For this reason, if the settings to enable the functions are not provided, desired scanned data may not be obtained. For example, suppose that a double-side printed document that contains a blank page and in which the orientations of the image data of the individual pages differ is to be output as desired scanned data. The desired scanned data here is data scanned on both sides and in which blank pages are removed and the image data of the individual pages are accurately oriented. If the duplex document scanning function is disabled, duplex document scanning is not executed although the document is a double-sided printed document, and as a result, only one side of the document is scanned and is output as scanned data. This requires the user to execute the scanning function again to obtain the scanned data of the other side not scanned, which requires unnecessary time and effort. If the blank-page removing function is disabled, scanned data containing blank pages is output. This requires the user to delete the blank pages from the scanned data manually, which takes much time and effort. If the document-orientation detecting function is disabled, the operation to rotate the pages containing image data in correspondence with the accurate orientations of the image data of the individual pages is not executed. This causes scanned data in which the top and bottom of the image data of the pages are the same to be output although the accurate orientations of the image data of the pages differ. This requires the user to rotate the orientations of pages of the scanned data containing not rotated image data, which takes much time and effort. Thus, if the setting of one of the above functions is disabled, the user who obtains the scanned data needs to execute the process of editing (post-processing) the scanned data to obtain desired data, which takes much time and effort.

Accordingly, this embodiment provides an image processing apparatus having a predetermined function for enabling the duplex document scanning function, the blank-page removing function, and the document-orientation detecting function in a single step. Specifically, when an operation for activating a predetermined function related to the scanning function is executed in the image processing apparatus, a predetermined setting button is displayed in response to display control. The predetermined setting button is for setting the predetermined function for collectively enabling at least the duplex document scanning function, the blank-page removing function, the document-orientation detecting function on a setting screen for a predetermined-function related to the scanning function. This allows reducing the time and effort that are taken because the setting of one of the duplex document scanning function, the blank-page removing function, and the document-orientation detecting function is not enabled.

In the case of an image processing apparatus capable of executing the duplex document scanning function, the blank-page removing function, and the document-orientation detecting function, the mode in which the predetermined setting button is enabled is displayed as the default of the setting screen for a predetermined-function related to the scanning function. This allows further reducing the time and effort that are taken because the setting of one of the duplex document scanning function, the blank-page removing function, and the document-orientation detecting function is not enables.

Examples of the predetermined function for the scanning function include the scan and send function and the scan and save function described above. In other words, the predetermined setting button is displayed on a scan-and-send function setting screen in response to an operation to activate the scan and send function (an application program corresponding to the scan and send function). The predetermined setting button may be displayed on a scan and save function setting screen in response to an operation to activate the scan and save function (an application program corresponding to the scan and save function). This also applies to other scanning functions. One example is a function capable of executing both the scan and send function and the scan and save function (an application program corresponding to both of the functions). In other words, the predetermined setting button may be displayed on a setting screen for the application program capable of executing both the scan and send function and the scan and save function in response to an operation to activate the application program capable of executing both the scan and send function and the scan and save function. The application program capable of executing both the scan and send function and the scan and save function may have simpler settings for the individual functions than the respective application programs for the scan and send function and the scan and save function. In other words, the application program capable of executing both the scan and send function and the scan and save function may be an application program capable of both the scan and send function and the scan and save function with minimum settings.

This allows the user to easily execute the settings of the functions for the scanning function. This saves many steps for obtaining desired data by editing (post-processing) the obtained scanned data, improving the usability in executing the scanning function.

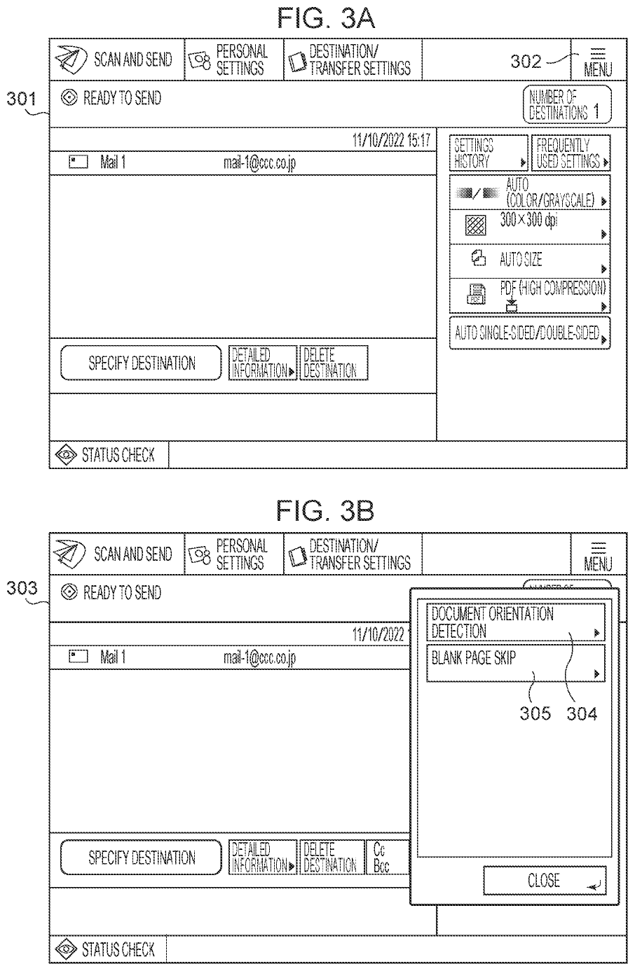

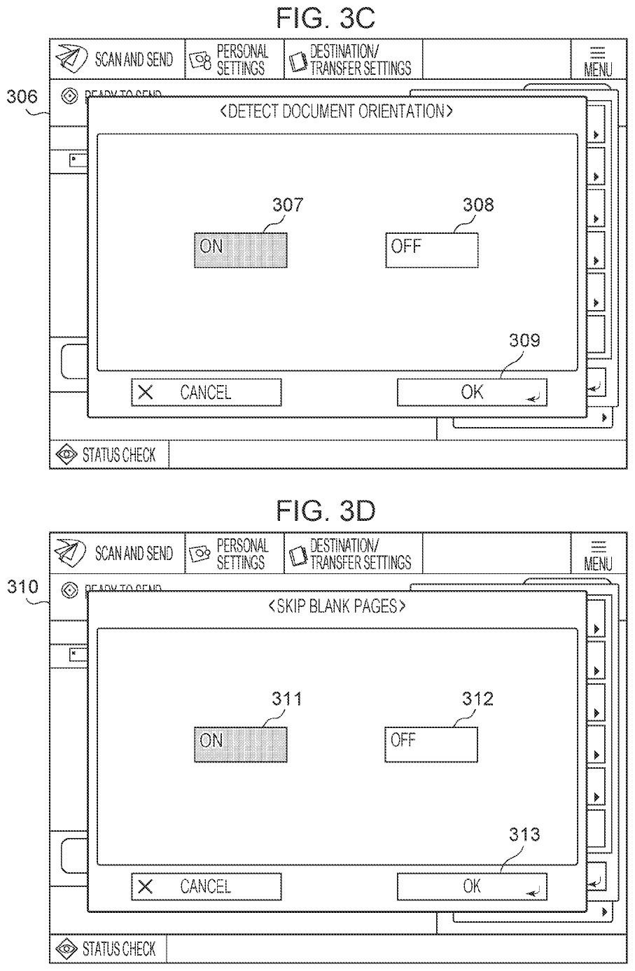

The predetermined setting buttons for the functions related to the scanning function of the image processing apparatus 103 will be described with reference to FIG. 3A to FIG. 7B.

FIGS. 3A to 3D are diagrams illustrating an example of the screen transition of the scan-and-send function setting screen (setting area) displayed on the operating unit 212 when the user toggles the document-orientation detecting function or the blank-page removing function on and off in the image processing apparatus 103 according to this embodiment.

The user can select functions related to the scanning function (application programs for executing the scanning function) on a main screen (not shown) displayed on the operating unit 212. The main screen is a screen displayed first when the image processing apparatus 103 is powered on and activated (or a screen displayed first after log-in). The main screen displays selectable regions (buttons, icons, or keys) for activating the various functions of the image processing apparatus 103 or applications corresponding to the functions. Examples of the functions of the image processing apparatus 103 include a copying function, a scan and save function, a scan and send function, a function capable of executing both the scan and send function and the scan and save function, and a facsimile function. In response to a button indicating the scan and send function being pressed by the user, with the main screen displayed, the CPU 201 activates the scan and send function to display a transmission standard screen 301 shown in FIG. 3A. This embodiment is described using the scan and send function as an example of the functions related to the scanning function. The screen transition similar to FIG. 3A to FIG. 7B may be executed for other functions related to the scanning function.

FIG. 3A illustrates the transmission standard screen 301 displayed on the operating unit 212, in which one e-mail address is set. For example, the mail address is the mail address of a user who is currently logging in the image processing apparatus 103. When the CPU 201 detects a “menu” key 302 being pressed on the transmission standard screen 301, the CPU 201 displays a menu selection screen 303 illustrated in FIG. 3B. The menu selection screen 303 displays a “document orientation detection” key 304 and a “blank page skip” key 305. When the CPU 201 detects the “document orientation detection” key 304 being pressed on the menu selection screen 303, the CPU 201 displays a document-orientation-detection setting screen 306 shown in FIG. 3C. The document-orientation-detection setting screen 306 displays an “ON” key 307 and an “OFF” key 308 so that the user can switch between on and off of the operation of the document-orientation detecting function. The “ON” key 307 and the “OFF” key 308 have exclusive relationship, in which only one can be enabled. In FIG. 3C, the “ON” key 307 is highlighted relative to the “OFF” key 308 so as to allow recognizing that the document-orientation detecting function is enabled. The form that the document-orientation detecting function is enabled is illustrative only. When the CPU 201 detects an “OK” key 309 being pressed on the document-orientation-detection setting screen 306 shown in FIG. 3C, the screen 306 returns to the transmission standard screen 301 shown in FIG. 3A. Here, the CPU 201 sets the value of a flag indicating whether to enable the document-orientation detecting function (hereinafter referred to as a document-orientation-detection setting flag) to “TRUE” (enabled). The value of the document-orientation-detection setting flag indicating a disabled state is “FALSE”. The value of the document-orientation-detection setting flag is temporarily stored in the RAM 208.

When the CPU 201 detects the “blank page skip” key 305 being pressed on the menu selection screen 303 shown in FIG. 3B, a blank-page-skip setting screen 310 shown in FIG. 3D is displayed. The blank-page-skip setting screen 310 displays an “ON” key 311 for enabling the blank-page removing function and an “OFF” key 312 for disabling the function so that the user can toggle the function on and off. The “ON” key 311 and the “OFF” key 312 have exclusive relationship, in which only one can be enabled. In FIG. 3D, the “ON” key 311 is highlighted relative to the “OFF” key 312 so as to allow recognizing that the blank-page removing function is enabled. The form that the blank-page removing function is enabled is illustrative only. When the CPU 201 detects an “OK” key 313 being pressed on the blank-page-skip setting screen 310 shown in FIG. 3D, the screen 310 returns to the transmission standard screen 301 shown in FIG. 3A. Here, the CPU 201 sets the value of a flag indicating whether to enable the blank-page removing function (hereinafter referred to as a blank-page-removal setting flag) to “TRUE” (enabled). The value of the blank-page-removal setting flag indicating a disabled state is “FALSE”. The value of the blank-page-removal setting flag is temporarily stored in the RAM 208.

The document-orientation-detection setting screen 306, the “document orientation detection” key 304, the blank-page-skip setting screen 310, and the “blank page skip” key 305 need not necessarily be displayed on the operating unit 212. In other words, the image processing apparatus 103 need not have the function to set whether to enable the document-orientation detecting function and the function to set whether to enable the blank-page removing function. If the function to set whether to enable the document-orientation detecting function and the function to set whether to enable the blank-page removing function are not provided, it may be determined whether to set the value of the document-orientation-detection setting flag to “TRUE” (enable) based on whether the image processing apparatus 103 has the document-orientation detecting function. It may be determined whether to set the value of the blank-page-removal setting flag to “TRUE” (enable) based on whether the image processing apparatus 103 has the blank-page removing function.

Whether the duplex document scanning function is available is determined based on whether the image processing apparatus 103 includes the ADF 225. In other words, if the image processing apparatus 103 includes the ADF 225, it is determined that the duplex document scanning function is available, and if the image processing apparatus 103 does not include the ADF 225, it is determined that the duplex document scanning function is unavailable. However, in the case of the image processing apparatus 103 including the ADF 225 and configured to set whether to use the ADF 225, it may be determined that the duplex document scanning function is available if the ADF 225 is set to be used, and it may be determined that the duplex document scanning function is unavailable if the ADF 225 is set not to be used.

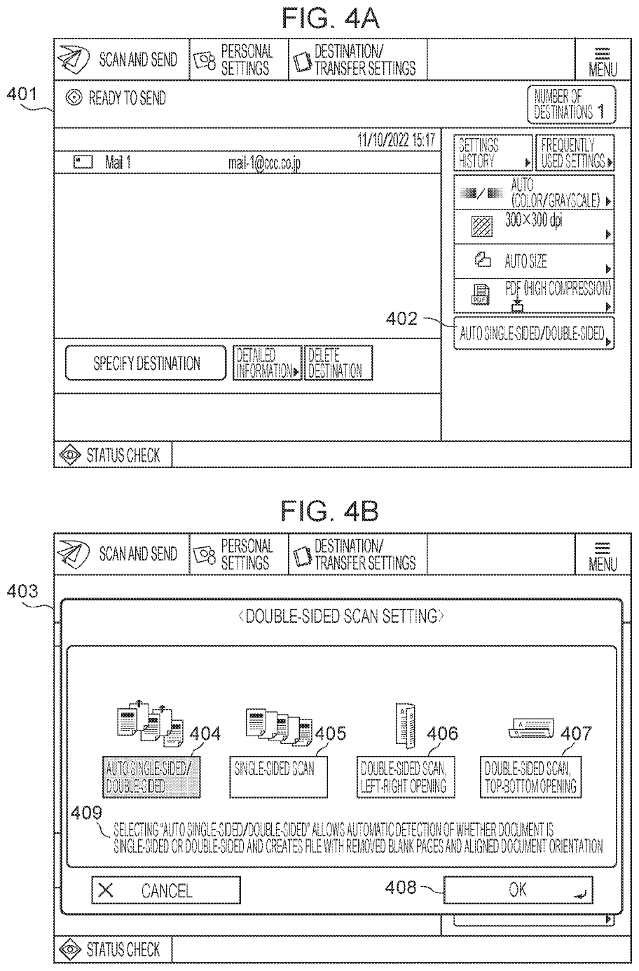

Referring next to FIGS. 4A and 4B, specific control of the image processing apparatus 103 capable of duplex document scanning in the case where the document-orientation-detection setting flag is “TRUE” and the blank-page-removal setting flag is “TRUE” will be described. Specifically, FIGS. 4A and 4B are diagrams illustrating an example of the screen transition of the scan-and-send function setting screen displayed on the operating unit 212 of the image processing apparatus 103 capable of duplex document scanning function when the document-orientation detecting function and the blank-page removing function are enabled and the scan and send function displayed on the operating unit 212 is activated. The CPU 201 displays a transmission standard screen 401 shown in FIG. 4A in response to a button for activating the scan and send function being pressed by the user, with the main screen displayed.

FIG. 4A illustrates the transmission standard screen 401 displayed on the operating unit 212, in which one e-mail address is set. For example, the mail address is the mail address of a user who is currently logging in the image processing apparatus 103. The transmission standard screen 401 includes a setting key (button) 402. The setting key 402 is an area in which the functions set for the scan and send function can be changed and in which the details of the set function are displayed. For the setting key 402, an “auto single-sided/double-sided” function to enable the duplex document scanning function, the blank-page removing function, and the document-orientation detecting function in a single step is set as the default of a setting for the scan and send function. In other words, the transmission standard screen 401 displayed in response to the activation of the scan and send function displays the “auto single-sided/double-sided” function in the area of the setting key 402. When the CPU 201 detects the setting key 402 being pressed on the transmission standard screen 401, the CPU 201 displays a setting selection screen 403 shown in FIG. 4B. The setting selection screen 403 displays an “auto single-sided/double-sided” key 404, a “single-sided scan” key 405, a “double-sided scan, left-right opening” key 406, and a “double-sided scan, top-bottom opening” key 407, which accept selection of the functions by the user. Information 409 is information (a message) for notifying the user that the both sides of the document set in the ADF 225 can be scanned and that the image data subjected to removal of blank pages and detection of the document orientation can be converted to a file and transmitted by setting the “auto single-sided/double-sided” key 404 and giving a send instruction. The setting screen 403 displays the “auto single-sided/double-sided” key 404 highlighted relative to the other functions so as to allow recognizing that “auto single-sided/double-sided” key 404 is enabled. (In other words, the information 409 indicates that the “auto single-sided/double-sided” function is set as the default of a setting for the scan and send function.)

The “single-sided scan” key 405 is a function to execute the single-sided document scanning function and to disable the blank-page removing function and the document-orientation detecting function in a single step. Some users want to scan one side of the document set in the ADF 225, convert the scanned data to a file, and transmit the file without executing the blank-page removing function and the document-orientation detecting function. Such users can save the time and effort to disable the document-orientation detecting function and the blank-page removing function shown in FIGS. 3A to 3D by selecting the “single-sided scan” function. The “single-sided scan” key 405 may allow detection of a document set on a platen glass. In other words, when the “single-sided scan” key 405 is selected, one side of the document set on the platen glass may be scanned, the scanned data may be converted to a file, and the file may be transmitted without executing the blank-page removing function and the document-orientation detecting function.

The “double-sided scan, left-right opening” key 406 is a function to execute a function to scan the both sides of a document printed on both sides so that the top and bottom the image data are the same on the both sides of the document when reversed (turned inside out) in line symmetry with respect to the left edge (or the right edge) of the document and to disable the blank-page removing function and the document-orientation detecting function in a single step. A user who wants to scan both sides (left-right opening) of the document set in the ADF 225, convert the scanned data to a file, and transmit the file without executing the blank-page removing function and the document-orientation detecting function can save the time and effort to disable the document-orientation detecting function and the blank-page removing function shown in FIGS. 3A to 3D by selecting the “double-sided scan, left-right opening” function.

The “double-sided scan, top-bottom opening” key 407 is a function to execute a function to scan the both sides of a document printed on both sides so that the top and bottom of the image data are the same on the both sides of the document when reversed (turned inside out) in line symmetry with respect to the upper edge (or the lower edge) of the document and to disable the blank-page removing function and the document-orientation detecting function in a single step. A user who wants to scan the both sides (top-bottom opening) of the document set in the ADF 225, convert the scanned data to a file, and transmit the file without executing the blank-page removing function and the document-orientation detecting function can save the time and effort to disable the document-orientation detecting function and the blank-page removing function shown in FIGS. 3A to 3D by selecting the “double-sided scan, top-bottom opening” function.

When the CPU 201 detects an “OK” key 408 being pressed on the setting screen 403 in FIG. 4B, the CPU 201 sets a function corresponding to one of the enabled keys and displays the transmission standard screen 401 in which the details of the set function is displayed in the area of the setting key 402.

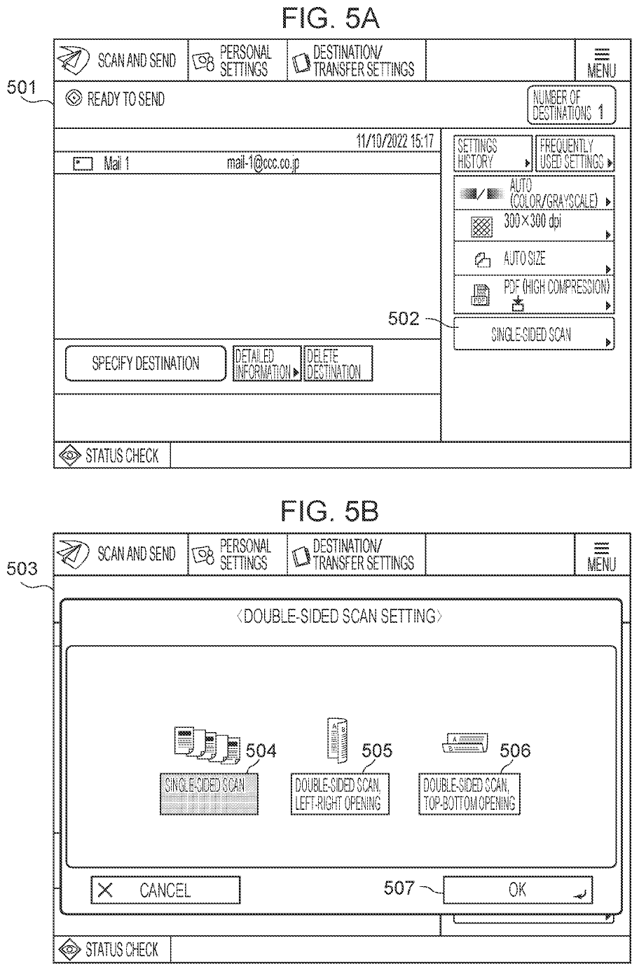

Referring next to FIGS. 5A and 5B, specific control of the image processing apparatus 103 capable of duplex document scanning in the case where at least one of the document-orientation-detection setting flag and the blank-page-removal setting flag is “FALSE” will be described. Specifically, FIGS. 5A and 5B are diagrams illustrating an example of the screen transition of a scan-and-send function setting screen displayed on the operating unit 212 of the image processing apparatus 103 capable of duplex document scanning function when at least one of the document-orientation detecting function and the blank-page removing function is disabled (one or both of the functions are disabled) and the scan and send function displayed on the operating unit 212 is activated. The CPU 201 displays a transmission standard screen 501 shown in FIG. 5A in response to a button for activating the scan and send function being pressed by the user, with the main screen displayed.

FIG. 5A illustrates the transmission standard screen 501 displayed on the operating unit 212, in which one e-mail address is set. For example, the mail address is the mail address of a user who is currently logging in the image processing apparatus 103. The transmission standard screen 501 includes a setting key 502. The setting key 502 is an area in which the functions set for the scan and send function can be changed and in which the details of the set function are displayed. For the setting key 502, a “single-sided scan” function, which is a predetermined function to scan one side of a document set in the ADF 225, convert the scanned data into a file, and transmit the file without operating (with disabling) the blank-page removing function and the document-orientation detecting function, is set as the default of a setting for the scan and send function. In other words, the transmission standard screen 501 displayed in response to activation of the scan and send function displays the “single-sided scan” function as the default in the area of the setting key 502.

When the CPU 201 detects the setting key 502 being pressed on the transmission standard screen 501, the CPU 201 displays a setting selection screen 503 shown in FIG. 5B. The setting selection screen 503 displays a “single-sided scan” key 504, a “double-sided scan, left-right opening” key 505, and a “double-sided scan, top-bottom opening” key 506, which accept user-selected functions. The setting selection screen 503 displays the “single-sided scan” key 504 highlighted relative to the other functions so as to allow recognizing that the “single-sided scan” key 504 is enabled. (In other words, the “single-sided scan” function is set as the default of a setting for the scan and send function.) When the CPU 201 detects an “OK” key 507 being pressed on the setting screen 503 in FIG. 5B, the CPU 201 sets a function corresponding to one of the enabled keys and displays the transmission standard screen 501 in which the details of the set function are displayed in the area of the setting key 402.

The functions represented by the “single-sided scan” key 504, the “double-sided scan, left-right opening” key 505, and the “double-sided scan, the top-bottom opening” key 506 are the same as the functions represented by the “single-sided scan” key 405, the “double-sided scan, left-right opening” key 406, and the “double-sided scan, top-bottom opening” key 407 shown in FIG. 4B, respectively.

Although an example of the screen of the image processing apparatus 103 capable of duplex document scanning in the case where at least one of the document-orientation-detection setting flag and the blank-page-removal setting flag is “FALSE” has been described with reference to FIGS. 5A and 5B, this is illustrative only. In the case where the duplex document scanning is available, the document-orientation-detection setting flag is “TRUE”, and the blank-page-removal setting flag is “FALSE”, the “auto single-sided/double-sided” key 402 or 404 illustrated in FIG. 4A or 4B may be displayed. The “auto single-sided/double-sided” key 402 or 404 in this case represents a function to execute the duplex document scanning function and the blank-page removing function and to disable the document-orientation detecting function in a single step.

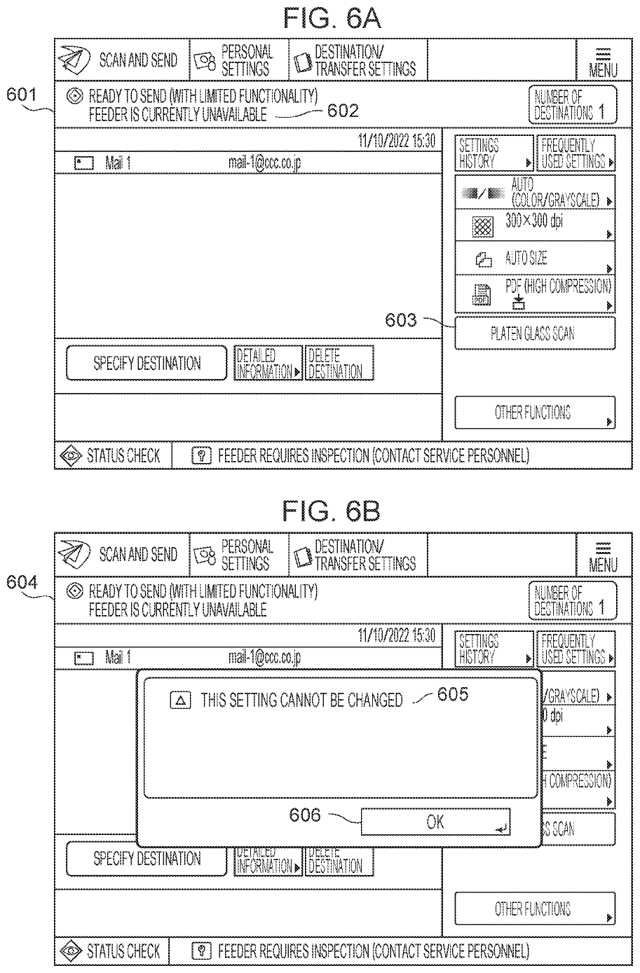

Referring next to FIGS. 6A and 6B, specific control in case of malfunction of the ADF 225 will be described using a transmission standard screen 601 displayed on the operating unit 212 as an example. FIGS. 6A and 6B illustrate an example of the screen transition of the transmission standard screen 601 displayed on the operating unit 212 in the case where a malfunction occurs in the ADF 225 and the scan and send function displayed on the operating unit 212 is activated in the image processing apparatus 103. In other words, in case of a malfunction of the ADF 225, the screens shown in FIGS. 6A and 6B are displayed irrespective of whether the blank-page removing function and the document-orientation detecting function are enabled. The CPU 201 displays the transmission standard screen 601 shown in FIG. 6A in response to a button for activating the scan and send function being pressed by the user, with the main screen displayed. Conceivable examples of the malfunction of the ADF 225 include a case where the documents on a document feed tray cannot be fed because of the failure of a motor included in the mechanism for conveying the documents onto the platen glass and a case where the fed document stops midway in the conveying path.

FIG. 6A illustrates the transmission standard screen 601 displayed on the operating unit 212, in which one e-mail address is set. For example, the mail address is the mail address of a user who is currently logging in the image processing apparatus 103. Information 602 is information (a message) for notifying the user that the mechanism for conveying the documents set in the ADF 225 onto the platen glass has a problem, so that the ADF 225 is unusable. The transmission standard screen 601 includes a setting key 603. The setting key 603 is an area for displaying the details of the set functions. For the setting key 603, a “platen glass scan” function, which is a function to scan the document set on the platen glass, convert the scanned data into a file, and transmit the file without activating (with disabling) the blank-page removing function and the document-orientation detecting function, is set as the default. The “platen glass scan” function is set as a fixed value. When the CPU 201 detects the setting key 603 being pressed on the transmission standard screen 601, the CPU 201 displays a warning screen 604 shown in FIG. 6B. The warning screen 604 displays information 605 (a message) for notifying the user that the setting for the scan and send function cannot be changed. In other words, in the case where the duplex document scanning function is unavailable, and the “platen glass scan” function is selected, the options of the “single-sided scan” key 404, the “double-sided scan, left-right opening” key 405, and the “double-sided scan, top-bottom opening” key 406 are not displayed. When the CPU 201 detects an “OK” key 606 being pressed on the warning screen 604 in FIG. 6B, the screen 604 returns to the transmission standard screen 601 shown in FIG. 6A.

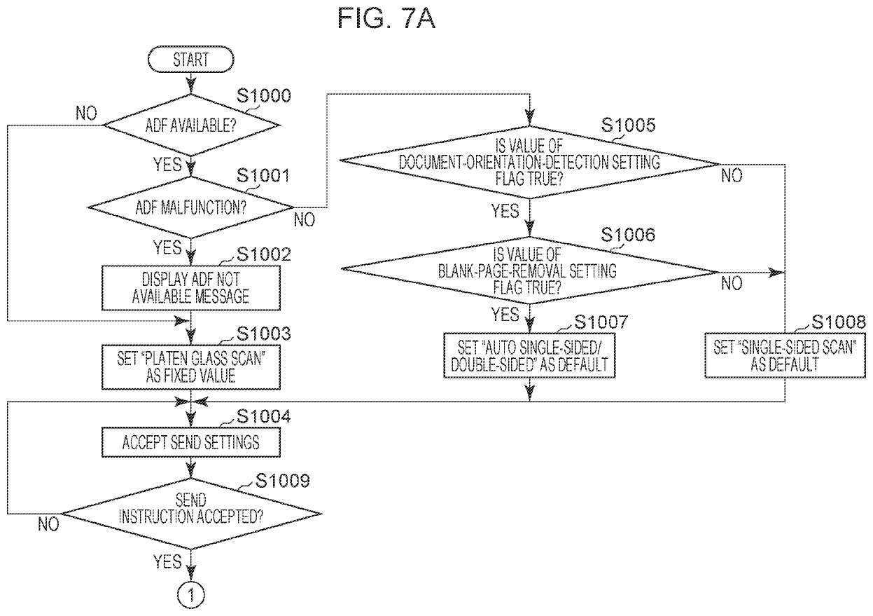

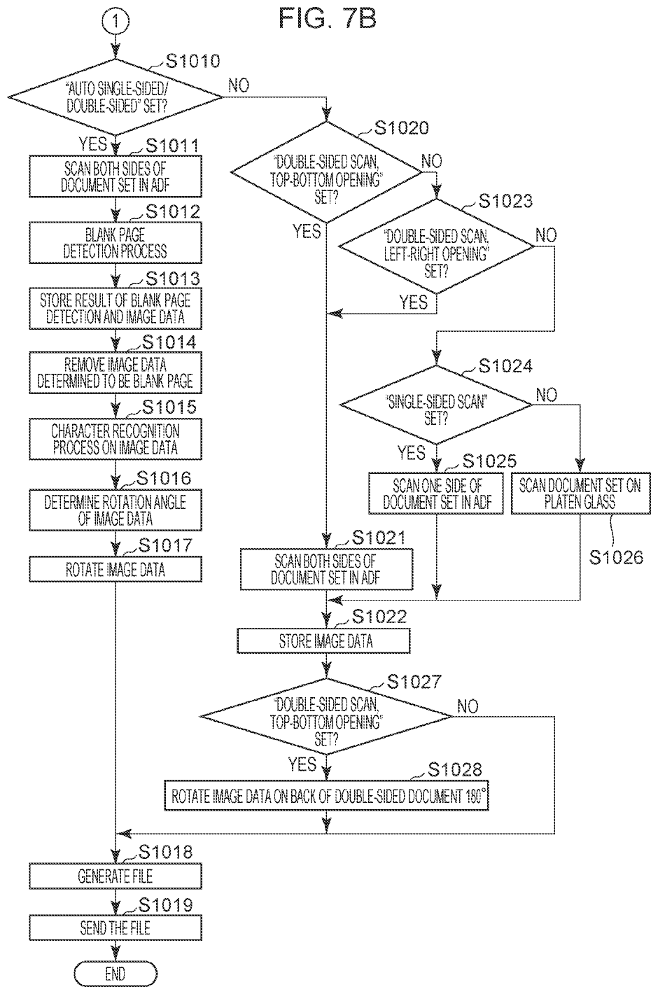

Referring next to FIGS. 7A and 7B, a function related to the scanning function of the image processing apparatus 103 according to this embodiment will be described. FIGS. 7A and 7B illustrate an example of a flowchart for executing the scan and send function as a function related to the scanning function of the image processing apparatus 103. The CPU 201 executes the steps of the flowchart of FIGS. 7A and 7B by executing a program stored in the ROM 209. The processing of this flowchart is started in response to an instruction to display a screen related to the scan and send function. For example, the processing is started in response to a button for activating the scan and send function being pressed by the user on the main screen. Alternatively, the processing may be started when the screen for the scan and send function is displayed, and the enabling/disabling of at least one of the “document orientation detection” key 304 and the “blank page skip” key 305 in FIG. 3B is changed. For example, the processing may be started when the “document orientation detection” key 304 is selected, one of the “ON” key 307 and the “OFF” key 308 is selected, and the “OK” key 309 is pressed on the displayed document-orientation-detection setting screen 306.

First in S1000, the CPU 201 determines whether the image processing apparatus 103 includes the ADF 225. If the CPU 201 determines that the image processing apparatus 103 includes the ADF 225, the process goes to S1001. If the CPU 201 determines that the image processing apparatus 103 does not include the ADF 225, the process goes to S1003. If the CPU 201 determines that the image processing apparatus 103 does not include the ADF 225, the process may go to S1002. In the case of the image processing apparatus 103 including the ADF 225 and configured to set whether to use the ADF 225, if the image processing apparatus 103 is determined to be set to use the ADF 225, the process goes to S1001, and if the image processing apparatus 103 is determined not to be set to use the ADF 225, the process goes to S1003. In other words, in this determination process, the CPU 201 determines whether the image processing apparatus 103 can use the ADF 225, in which if the ADF 225 is determined to be available, then the process goes to S1001, and if ADF 225 is determined to be unavailable, then the process goes to S1003.

Next in S1001, the CPU 201 determines whether the ADF 225 is experiencing a malfunction. If the CPU 201 determines that the ADF 225 is experiencing a malfunction, the process goes to S1002, and if the CPU 201 determines that the ADF 225 is not experiencing a malfunction, the process goes to S1005.

In S1002, the CPU 201 determines to display the information 602 for notifying the user that the ADF 225 is unavailable and goes to the process of S1003.

In S1003, the CPU 201 sets, as a setting for the scan and send function, the “platen glass scan” function as a fixed value. Thus, the transmission standard screen 601 shown in FIG. 6A is displayed. Then, the process goes to S1004. When the “platen glass scan” function is selected in S1003, the warning screen 604 shown in FIG. 6B is displayed.

In S1005, which follows S1001 in which it is determined to be NO, the CPU 201 refers to the value of the document-orientation-detection setting flag stored in the RAM 208 to determine whether the value is “TRUE”. If the CPU 201 determines that the value of the document-orientation-detection setting flag is “TRUE”, the process goes to S1006, and if the CPU 201 determines that the value of the document-orientation-detection setting flag is not “TRUE”, the process goes to S1008.

In S1006, the CPU 201 refers to the value of the blank-page-removal setting flag stored in the RAM 208 to determine whether the value is “TRUE”. If the CPU 201 determines that the value of the blank-page-removal setting flag is “TRUE”, the process goes to S1007, and if the CPU 201 determines that the value of the blank-page-removal setting flag is not “TRUE”, then the process goes to S1008.

In S1007, the CPU 201 sets, as a setting for the scan and send function, the “auto single-sided/double-sided” function as the default. Thus, the transmission standard screen 401 shown in FIG. 4A is displayed. Then, the process goes to S1004.

In S1008 following S1005 and S1006 in which it is determined to be NO, the CPU 201 sets, as a setting for the scan and send function, the “single-sided scan” function as the default. Thus, the transmission standard screen 501 shown in FIG. 5A is displayed. Thereafter, the process goes to S1004.

In S1004, the CPU 201 accepts the destination of transmission to the file-sharing server 101 or the mail server 102, color, resolution, scan size, file format, and other settings and goes to the process of S1009.

In S1009, the CPU 201 determines whether a start key (not shown) has been pressed. In other words, the CPU 201 determines whether an instruction from the user to transmit scanned data has been accepted. If the CPU 201 determines that the send instruction has been accepted, the process goes to S1010, and if no send instruction has been given, the process returns to S1004.

In S1010, the CPU 201 determines whether the “auto single-sided/double-sided” function has been set as a setting for the scan and send function. If the CPU 201 determines that “auto single-sided/double-sided” is set, the process goes to S1011, and if the CPU 201 determines that “auto single-sided/double-sided” is not set, the process goes to S1020.

In S1011, the CPU 201 conveys the plurality of documents set in the ADF 225 in sequence, scans the image data on both sides of the documents with the scanner 205, and goes to the process of S1012.

In S1012, the CPU 201 performs a blank-page determination process with the scanner 205 and goes to the process of S1013. The blank-page determination process is a process of determining whether the pages of the documents are blank. The blank-page determination process with the scanner 205 is mainly performed using the histogram and edge detection of the input image data. The histogram is generated at a predetermined sampling pitch for each segmented region. The edge detection allows determination of contents that are difficult to determine blank pages only with the histogram. The edge detection of the input image data is performed for each segmented region at a predetermined sampling pitch, and the edges and the detected pixels are counted for each segmented region. The blank-page determination process is performed based on the respective thresholds of the histogram and the edge detection to determine whether the pages are blank from the result of blank page determination using the histogram and the edge detection.

In S1013, the CPU 201 stores the image data scanned with the scanner 205 in the HDD 203 so as to associate the blank-page determination result sent from the scanner 205 with the individual pages of the image data and goes to the process of S1014.

In S1014, after the image data with the blank-page determination result is created in the HDD 203, the CPU 201 removes the image data of pages determined to be blank based on the blank-page determination result with only the image data of pages not determined to be blank left and goes to the process of S1015.

In S1015, the CPU 201 executes an optical character recognition (OCR) process on the image data of the pages not determined to be blank and goes to the process of S1016.

In S1016, the CPU 201 determines the orientation of the document (document orientation), determines the rotation angle of the image data from the document orientation, and goes to the process of S1017. In S1016, the CPU 201 determines the top and bottom of the document (document orientation) from, for example, the top and bottom of the detected characters or symbols, and determines the rotation angle of the image data so that the detected document orientation matches the top and bottom of the file created from the image data. For example, if the CPU 201 determines that the document orientation is “upward”, the CPU 201 determines “0 degree” as the rotation angle of the image data, if “leftward”, “90 degrees rightward”, if “rightward”, “90 degrees leftward”, and if “downward”, “180 degrees”.

In S1017, the CPU 201 causes the image rotating unit 220 shown in FIG. 2 to execute an image data rotation process at the image data rotation angle determined in S1016 and goes to the process of S1018.

In S1020 following S1010 in which it is determined that “auto single-sided/double-sided” is not set as a setting for the scan and send function, the CPU 201 determines whether “double-sided scan, top-bottom opening” is set as a setting for the scan and send function. If the CPU 201 determines that “double-sided scan, top-bottom opening” is set, the process goes to S1021, and if the CPU 201 determines that “double-sided scan, top-bottom opening” is not set, then the process goes to S1023.

In S1021, the CPU 201 conveys the plurality of documents set in the ADF 225 in sequence, scans the images on both sides of the documents with the scanner 205, and goes to the process of S1022.

In S1022, the CPU 201 stores the image data scanned with the scanner 205 in the HDD 203 and goes to the process of S1027.

In S1023 following S1020 in which it is determined to be NO, the CPU 201 determines whether “double-sided scan, left-right opening” is set as a setting for the scan and send function. If the CPU 201 determines that “double-sided scan, left-right opening” is set, the process goes to S1021, and if the CPU 201 determines that “double-sided scan, left-right opening” is not set, then the process goes to S1024.

In S1024, the CPU 201 determines whether “single-sided scan” is set as a setting for the scan and send function. If the CPU 201 determines that “single-sided scan” is set, the process goes to S1025, and if CPU 201 determines that “single-sided scan” is not set, the process goes to S1026.

In S1025, the CPU 201 conveys the plurality of documents set in the ADF 225 in sequence, scans the image data on one side of the documents with the scanner 205, and goes to the process of S1022.

In S1026, the CPU 201 scans the image data of the document set on the platen glass and goes to the process of S1022.

In S1027 following the process of S1022, the CPU 201 determines whether “double-sided scan, top-bottom opening” is set as a setting for the scan and send function. If the CPU 201 determines that “double-sided scan, top-bottom opening” is set, the process goes to S1028, and if the CPU 201 determines that “double-sided scan, top-bottom opening” is not set, then the process goes to S1018.

In S1028, the CPU 201 causes the image rotating unit 220 shown in FIG. 2 to execute the process of rotating the image data on the back of the double-sided document 180 degrees and goes to the process of S1018. When using a document that is printed on both sides such that the top and bottom of the image are the same on the both sides of the document when reversed around the upper edge (or the lower edge) of the document, the user can obtain images aligned in the upright direction by rotating the image data on the back of the double-sided document 180 degrees.

In S1018 following the processes of S1017 and S1028, and S1027 in which it is determined to be NO, the CPU 201 generates the file of the image data for transmission according to the file format specified in S1004 and goes to the process of S1019.

In S1019, the CPU 201 transmits the file generated in S1018 to the designation specified in S1004 and terminates the processing of this flowchart.

Although this flowchart is a flowchart for a case in which an instruction to execute the scan and send function is given, a similar flowchart applies to a case where another function for the scanning function is to be executed. Specifically, a flowchart for the scan and save function may be executed in response to an instruction to execute the scan and save function. In the flowchart for the scan and save function, a storing process is executed in S1019 of FIG. 7B instead of the transmission process.

Providing the predetermined setting button for enabling predetermined functions in a single step as in the above embodiment allows the user to easily execute the setting of the functions for the scanning function. This configuration allows the user to save the time and effort to execute a process of editing (post-processing) the obtained scanned data by himself/herself in order to obtain desired data. This improves the usability in executing the scanning function. Specifically, in the case where the document-orientation detecting function and the blank-page removing function are enabled, the “auto single-sided/double-sided” function is set in advance as the default on the scanning-and-transmitting-function setting screen. This configuration allows the user to easily obtain desired scanned data subjected to the document-orientation detecting function and the blank-page removing function only by setting documents in the ADF and giving an instruction to execute the scan and send function.

Furthermore, by pressing the button representing the “auto single-sided/double-sided” function, a function selection screen that allows the user to select other functions, such as the “single-sided scan” function, is displayed, which facilitates switching the setting to another function. This allows the user to save the time and effort to switch the setting to enable or disable the document-orientation detecting function and the blank-page removing function, improving the user convenience.

In the above embodiment, the “auto single-sided/double-sided” function is a predetermined function for performing an operation to convert scanned data subjected to at least the duplex document scanning function, the blank-page removing function, and the document-orientation detecting function into a file and transmit the file. However, the predetermined function may include other functions. Examples of the other functions include a function to execute scanning in a predetermined color mode, a function to execute scanning at a predetermined resolution, and a function to execute scanning in a predetermined scan size.

### Second Embodiment

In the first embodiment, the “platen glass scan” function for achieving the operation to scan a document set on the platen glass and transmit the image data in a file format without performing the blank page removal and document orientation detection in a case where the ADF is experiencing a malfunction is set as a fixed value. In a second embodiment in case of a malfunction of the ADF, “auto platen glass scan”, which is a function other than the “platen glass scan” function, can also be selected with reference to the value of the document-orientation-detection setting flag and the value of the blank-page-removal setting flag. The “auto platen glass scan” will be described later. In this embodiment, only the difference from the first embodiment will be described.

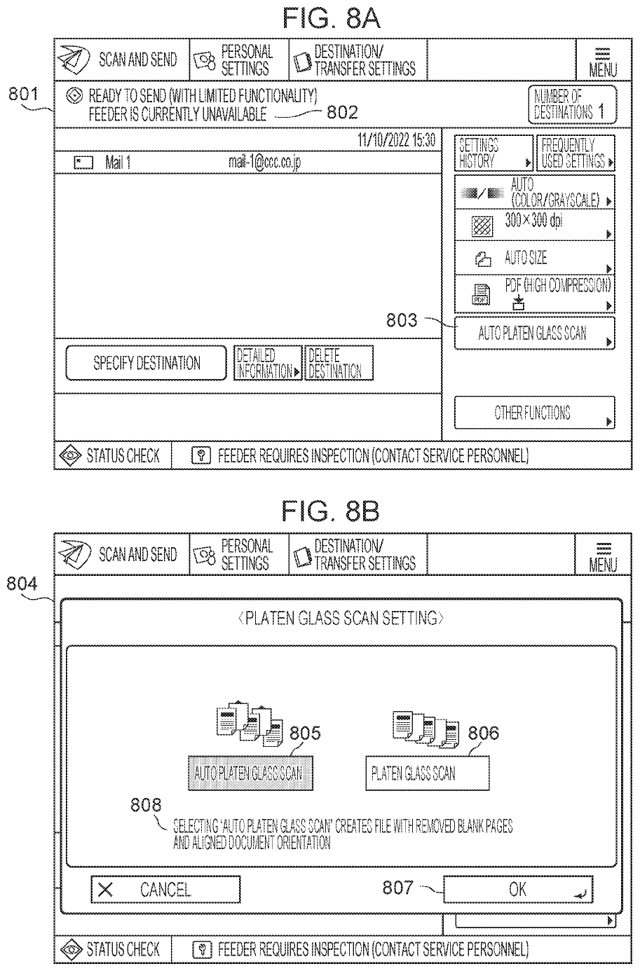

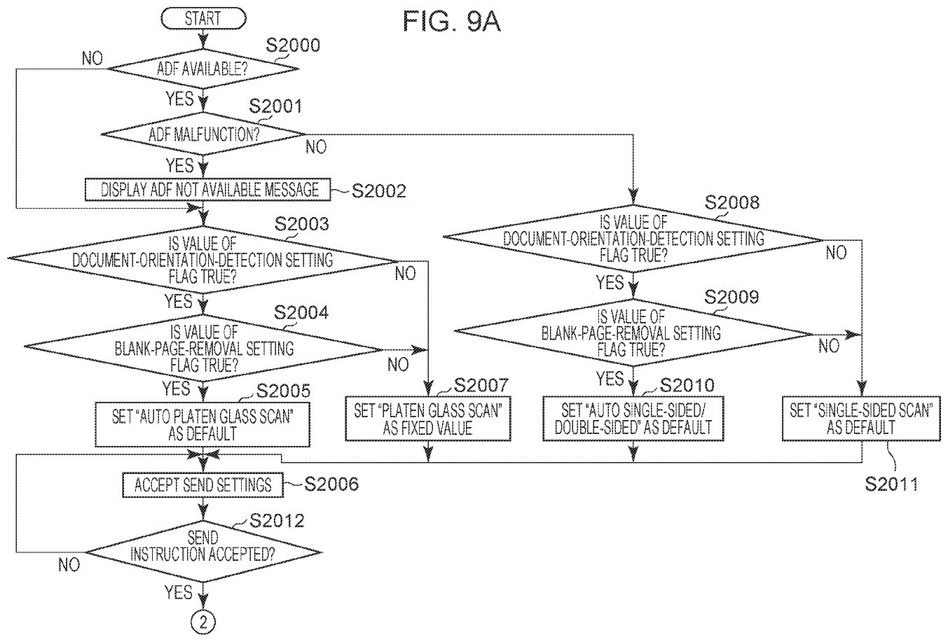

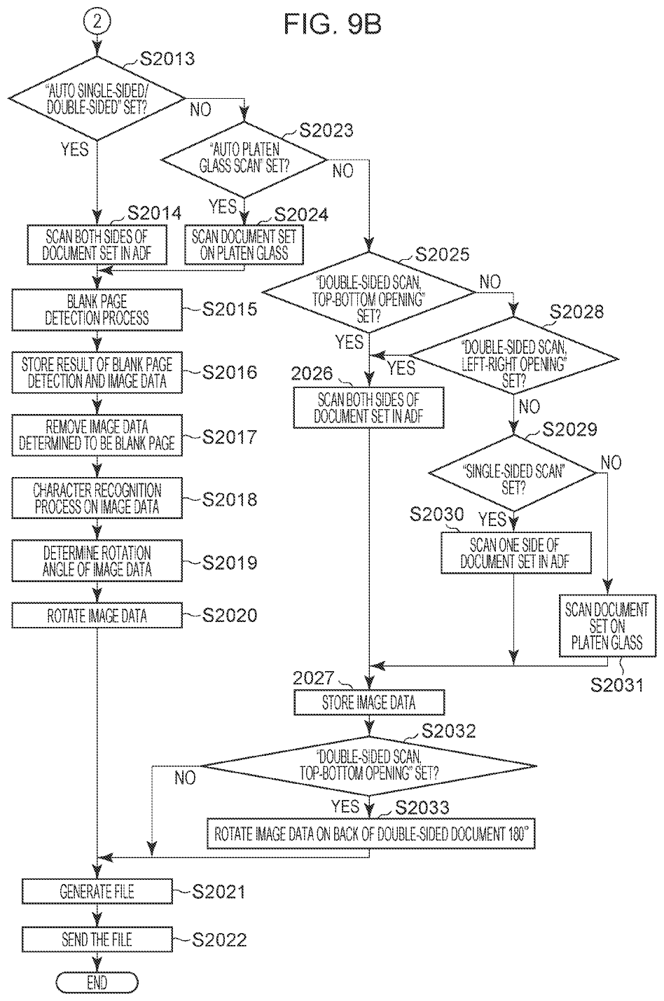

Predetermined setting buttons for the scanning function of the image processing apparatus 103 will be described with reference to FIGS. 8A and 8B and FIGS. 9A and 9B.

FIGS. 8A and 8B are diagrams illustrating an example of the screen transition of a setting screen for the scan and send function displayed on the operating unit 212 in case of a malfunction of the ADF 225 and in which the document-orientation detecting function and the blank-page removing function are enabled in the image processing apparatus 103 according to the second embodiment.

In response to a button for activating the scan and send function being pressed by the user, with the main screen displayed, the CPU 201 displays a transmission standard screen 801 shown in FIG. 8A.

FIG. 8A illustrates the transmission standard screen 801 displayed on the operating unit 212, in which one e-mail address is set. For example, the mail address is the mail address of a user who is currently logging in the image processing apparatus 103. Information 802 is information (a message) for notifying the user that a mechanism for conveying the documents set in the ADF 225 to the platen glass is experiencing a problem, so that the ADF 225 cannot be used. The transmission standard screen 801 includes a setting key 803. The setting key 803 is an area that displays the details of the set function. In the setting key 803, an “auto platen glass scan” function for achieving an operation for scanning a document set on the platen glass and transmitting the scanned data subjected to the blank-page removing function and the document-orientation detecting function in a file format is set as the default of the scan and send function. When the CPU 201 detects the setting key 803 being pressed on the transmission standard screen 801, the CPU 201 displays a setting selection screen 804 shown in FIG. 8B. The setting selection screen 804 displays an “auto platen glass scan” key 805 and a “platen glass scan” key 806 to accept a function selected by the user. Information 808 is information (a message) for notifying the user that the document set on the platen glass can be scanned and that the scanned data subjected to the blank-page removing function and the document-orientation detecting function can be transmitted in a file format by setting the “auto platen glass scan” key 805 and giving a send instruction. The setting selection screen 804 display the “auto platen glass scan” key 805 highlighted relative to the other function so that the user can recognize that the “auto platen glass scan” key 805 is enabled. The “platen glass scan” key 806 is a function to scan the document set on the platen glass, convert the scanned data into a file without executing the blank-page removing function and the document-orientation detecting function, and transmit the file. In other words, a user who wants to convert the scanned data into a file and transmit the file while executing (enabling) the blank-page removing function and the document-orientation detecting function can save the time and effort to enable the document-orientation detecting function and the blank-page removing function shown in FIGS. 3A to 3D by selecting the “auto platen glass scan” function. When the CPU 201 detects an “OK” key 807 being pressed on the setting selection screen 804 in FIG. 8B, the CPU 201 sets a function corresponding to one of the enabled keys and displays the transmission standard screen 801 in which the details of the set function is displayed in the area of the setting key 803.

Referring next to FIGS. 9A and 9B, functions related to the scanning function of the image processing apparatus 103 according to this embodiment will be described. FIGS. 9A and 9B illustrate a flowchart for executing the scan and send function as a function related to the scanning function of the image processing apparatus 103. The CPU 201 executes the steps of the flowchart in FIGS. 9A and 9B by executing a program stored in the ROM 209. The processing of this flowchart is started in response to an instruction to execute the scan and send function. For example, the processing is started in response to a button for activating the scan and send function being pressed by the user on the main screen.

First in S2000, the CPU 201 determines whether the image processing apparatus 103 includes the ADF 225. If the CPU 201 determines that the image processing apparatus 103 includes the ADF 225, the process goes to S2001, and if the CPU 201 determines that the image processing apparatus 103 does not include the ADF 225, the process goes to S2003. If the CPU 201 determines that the image processing apparatus 103 does not include the ADF 225, the process may go to S2002.

Since the processes from S2001 to S2002 are the same as the processes from S1001 to S1002, descriptions thereof will be omitted.

In S2003, the CPU 201 refers to the value of the document-orientation-detection setting flag stored in the RAM 208 to determine whether the value is “TRUE”. If the CPU 201 determines that the value of the document-orientation-detection setting flag is “TRUE”, the process goes to S2004, and if the CPU 201 determines that the value of the document-orientation-detection setting flag is not “TRUE”, then the process goes to S2007.

In S2004, the CPU 201 refers to the value of the blank-page-removal setting flag stored in the RAM 208 to determine whether the value is “TURE”. If the CPU 201 determines that the value of the blank-page-removal setting flag is “TURE”, the process goes to S2005, and if the CPU 201 determines that the value of the blank-page-removal setting flag is not “TURE”, then the process goes to S2007.

In S2005, the CPU 201 sets the “auto platen glass scan” function to scan a document set on the platen glass as the default of the scan and send function on the transmission standard screen 801 in FIG. 8A and goes to the process of S2006.

In S2007 following S2003 in which the value of the document-orientation-detection setting flag is determined not to be “TRUE”, the CPU 201 sets the “platen glass scan” function to scan the document set on the platen glass, convert the image data into a file, and transmitting the file without performing blank page removal and document orientation detection as a fixed value of the scan and send function. Then, the process goes to S2006.

Since the process of S2006 is the same as the process of S1004, a description there of will be omitted.

Since the processes from S2008 to S2014 are the same as the processed from S1005 to S1011, descriptions thereof will be omitted.

In S2023 following S2013 in which the CPU 201 determines that “auto single-sided/double-sided” is not set as a setting for the scan and send function, the CPU 201 determines whether “auto platen glass scan” is set as a function for the scan and send function. If the CPU 201 determines that “auto platen glass scan” is set, the process goes to S2024, and if the CPU 201 determines that “auto platen glass scan” is not set, the process goes to S2025.

In S2024, the CPU 201 scan the document set on the platen glass and goes to the process of S2015.

In S2015 following S2014 and S2024, the CPU 201 performs blank page determination with the scanner 205 and goes to the process of S2016.

Since the processes from S2016 to S2022 are the same as the processes from S1013 to S1019, descriptions thereof will be omitted.

In S2025 following S2023 in which it is determined that “auto platen glass scan” is not set as a setting for the scan and send function, the CPU 201 determines whether “double-sided scan, top-bottom opening” is set as a setting for the scan and send function. If the CPU 201 determines that “double-sided scan, top-bottom opening” is set, the process goes to S2026, and if the CPU 201 determines that “double-sided scan, top-bottom opening” is not set, the process goes to S2028.

Since the processes from S2026 to S2033 are the same as the processes from S1021 to S1028, descriptions thereof will be omitted.

According to the above embodiment, even in case where a malfunction occurs in the ADF, rendering the duplex document scanning function unusable, if the document-orientation detecting function and the blank-page removing function are enabled, the “auto platen glass scan” function is preset as the default for the scan and send function. Thus, even in case of a malfunction of the ADF, scanned data processed with the document-orientation detecting function and the blank-page removing function can easily be provided.

In this embodiment, when the duplex document scanning function is unusable, the “auto platen glass scan” function is preset as the default for the scan and send function.

However, the “auto platen glass scan” function may be preset as the default for the scan and send function when the duplex document scanning function and one of the document-orientation detecting function and the blank-page removing function is unusable. The “auto platen glass scan” function in this case enables only one usable function of the document-orientation detecting function and the blank-page removing function.

### OTHER EMBODIMENTS

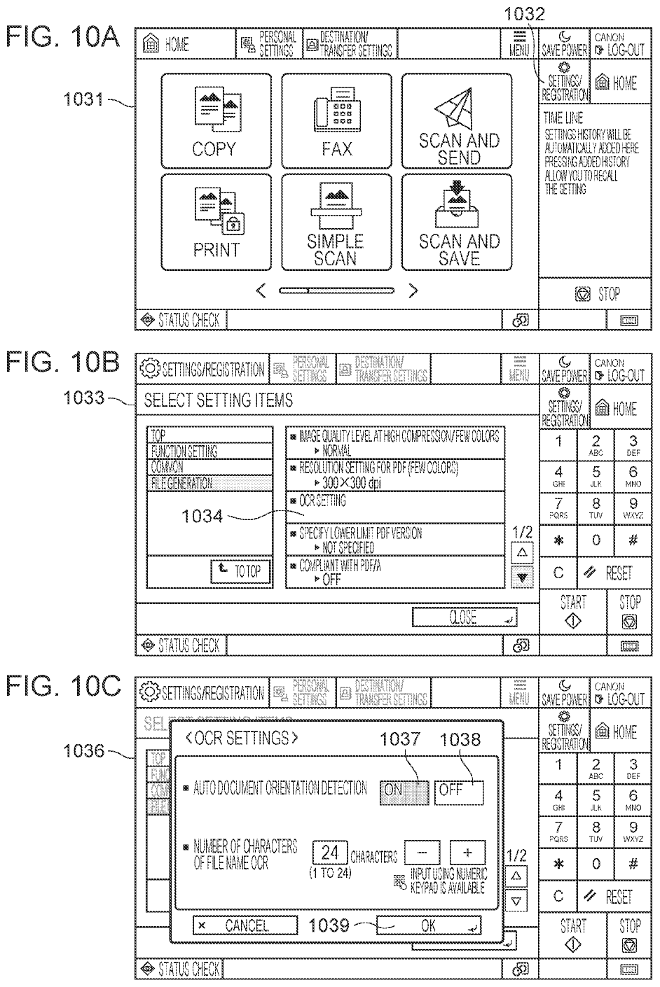

FIG. 3A to FIG. 6B in the above embodiment may be replaced with FIG. 10A to FIG. 13B. In other words, the screens in FIG. 10A to FIG. 13B corresponding to FIG. 3A to FIG. 6B may be applied to the above embodiment. The screens of FIG. 10A to FIG. 13B will be specifically described.

A “simple scan” function in FIGS. 10A to 10C is a transmission function to transmit image data scanned by the image processing apparatus 103 to a predetermined destination. The “simple scan” function is an application that allows for simpler settings than the “scan and send” function having a similar transmission function. The number of functions of the “simple scan” function is smaller than the number of functions of the “scan and send” function.

FIGS. 10A to 10C are diagrams illustrating an example of the screen transition of a simple-scan-function setting screen (setting area) displayed on the operating unit 212 when the user switches between ON and OFF of the document-orientation detecting function or the blank-page removing function in the image processing apparatus 103 of this embodiment.

FIG. 10A illustrates a main screen 1031 for selecting applications (functions) displayed on the display unit 212 of the image processing apparatus 103. The main screen is a screen displayed first when the image processing apparatus 103 is powered on and activated (or a screen displayed first after log-in). The main screen displays selectable regions (buttons, icons, or keys) for activating the various functions of the image processing apparatus 103 or applications corresponding to the functions. Examples of the functions of the image processing apparatus 103 include a copying function, a scan and save function, and a printing function. When the CPU 201 detects a “settings/registration” key 1032 being pressed on the main screen 1031, a menu selection screen 1033 shown in FIG. 10B is displayed. The menu selection screen 1033 displays an “OCR setting” key 1034. When the CPU 201 detects the “OCR setting” key 1034 being pressed on the menu selection screen 1033, a document-orientation-detection setting screen 1036 shown in FIG. 10C is displayed. The document-orientation-detection setting screen 1036 displays an “ON” key 1037 and an “OFF” key 1038 so that the user can switch between ON and OFF of the operation of the document-orientation detecting function. The “ON” key 1037 and the “OFF” key 1038 have exclusive relationship, in which only one can be enabled. In FIG. 10C, the “ON” key 1037 is highlighted relative to the “OFF” key 1038 so as to allow recognizing that the document-orientation detecting function is enabled. The form that the document-orientation detecting function is enabled is illustrative only. When the CPU 201 detects an “OK” key 1039 being pressed on the document-orientation-detection setting screen 1036 shown in FIG. 10C, the screen 1036 returns to the main screen 1031 shown in FIG. 10A. Here, the CPU 201 sets the value of the document-orientation-detection setting flag to “TRUE” (enabled). The value of the document-orientation-detection setting flag indicating a disabled state is “FALSE”. The value of the document-orientation-detection setting flag is temporarily stored in the RAM 208.

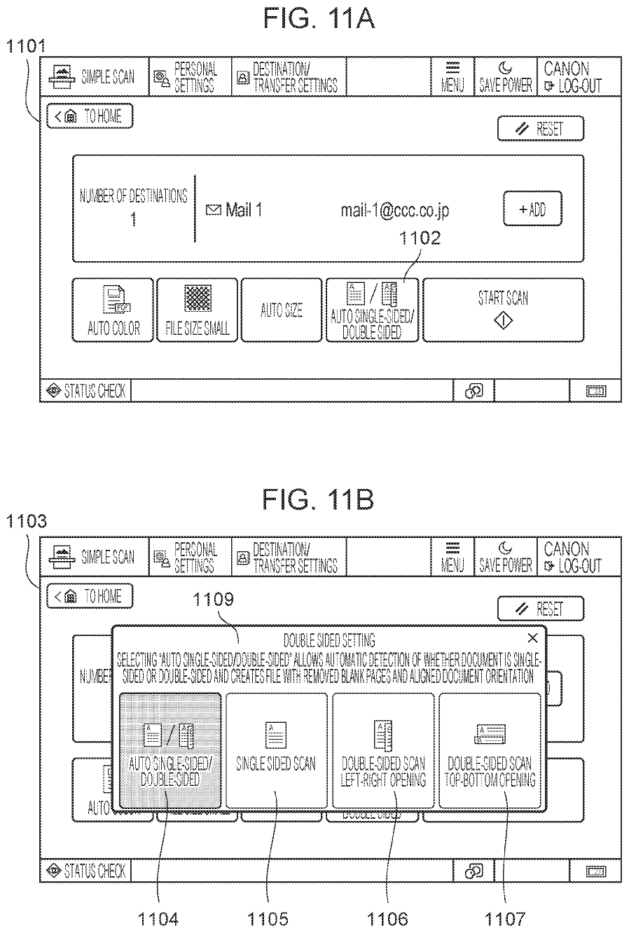

FIGS. 11A and 11B are diagrams illustrating specific control of the image processing apparatus 103 capable of duplex document scanning in the case where the document-orientation-detection setting flag is “TRUE” and the blank-page-removal setting flag is “TRUE”. Specifically, FIGS. 11A and 11B are diagrams illustrating an example of the screen transition of a simple-scan function setting screen displayed on the operating unit 212 of the image processing apparatus 103 capable of duplex document scanning function when the document-orientation detecting function and the blank-page removing function are enabled and the simple scan function displayed on the operating unit 212 is activated. The CPU 201 displays a transmission standard screen 1101 shown in FIG. 11A in response to a button for activating the simple scan function being pressed by the user, with the main screen 1031 displayed.

FIG. 11A illustrates the transmission standard screen 1101 displayed on the operating unit 212, in which one e-mail address is set. For example, the mail address is the mail address of a user who is currently logging in the image processing apparatus 103. The transmission standard screen 1101 includes a setting key (button) 1102. The setting key 1102 is an area in which the functions set for the simple scan function can be changed and in which the details of the set function are displayed. For the setting key 1102, an “auto single-sided/double-sided” function to enable the duplex document scanning function, the blank-page removing function, and the document-orientation detecting function in a single step is set as the default of a setting for the simple scan function. In other words, the transmission standard screen 1101 displayed in response to the activation of the simple scan function displays the “auto single-sided/double-sided” function in the area of the setting key 1102.

When the CPU 201 detects the setting key 1102 being pressed on the transmission standard screen 1101, the CPU 201 displays a setting selection screen 1103 shown in FIG. 11B. The setting selection screen 1103 displays an “auto single-sided/double-sided” key 1104, a “single-sided scan” key 1105, a “double-sided scan, left-right opening” key 1106, and a “double-sided scan, top-bottom opening” key 1107, which accept selection of the functions by the user. Information 1109 is information (a message) for notifying the user that the both sides of the document set in the ADF 225 can be scanned and that the image data subjected to removal of blank pages and detection of the document orientation can be converted to a file and transmitted by setting the “auto single-sided/double-sided” key 1104 and giving a send instruction. The setting screen 1103 displays the “auto single-sided/double-sided” key 1104 highlighted relative to the other functions so as to allow recognizing that the “auto single-sided/double-sided” key 1104 is enabled. (In other words, the information 1109 indicates that the “auto single-sided/double-sided” function is set as the default of a setting for the simple scan function.)

The “single-sided scan” key 1105 is a function to execute the single-side document scanning function and to disable the blank-page removing function and the document-orientation detecting function in a single step. A user who wants to scan one side of the document set in the ADF 225, convert the scanned data to a file, and transmit the file without executing the blank-page removing function and the document-orientation detecting function can save the time and effort to disable the document-orientation detecting function and the blank-page removing function shown in FIGS. 10A to 10C by selecting the “single-sided scan” function. The “single-sided scan” key 1105 may allow detection of a document set on a platen glass. In other words, when the “single-sided scan” key 1105 is selected, one side of the document set on the platen glass may be scanned, the scanned data may be converted to a file, and the file may be transmitted without executing the blank-page removing function and the document-orientation detecting function.

The “double-sided scan, left-right opening” key 1106 is a function to execute a function to scan the both sides of a document printed on both sides so that the top and bottom of the image data are the same on the both sides of the document when reversed (turned inside out) in line symmetry with respect to the left edge (or the right edge) of the document and to disable the blank-page removing function and the document-orientation detecting function in a single step. A user who wants to scan the both sides (left-right opening) of the document set in the ADF 225, convert the scanned data to a file, and transmit the file without executing the blank-page removing function and the document-orientation detecting function can save the time and effort to disable the document-orientation detecting function and the blank-page removing function shown in FIGS. 10A to 10C by selecting the “double-sided scan, left-right opening” function.

The “double-sided scan, top-bottom opening” key 1107 is a function to execute a function to scan the both sides of a document printed on both sides so that the top and bottom of the image data are the same on the both sides of the document when reversed (turned inside out) in line symmetry with respect to the upper edge (or the lower edge) of the document and to disable the blank-page removing function and the document-orientation detecting function in a single step. A user who wants to scan the both sides (top-bottom opening) of the document set in the ADF 225, convert the scanned data to a file, and transmit the file without executing the blank-page removing function and the document-orientation detecting function can save the time and effort to disable the document-orientation detecting function and the blank-page removing function shown in FIGS. 11A and 11B by selecting the “double-sided scan, top-bottom opening” function.

When the CPU 201 detects one of the keys 1104 to 1107 being pressed on the setting screen 1103 in FIG. 11B, the CPU 201 sets a function corresponding to one of the enabled keys and displays the transmission standard screen 1101 in which the details of the set function is displayed in the area of the setting key 1102.

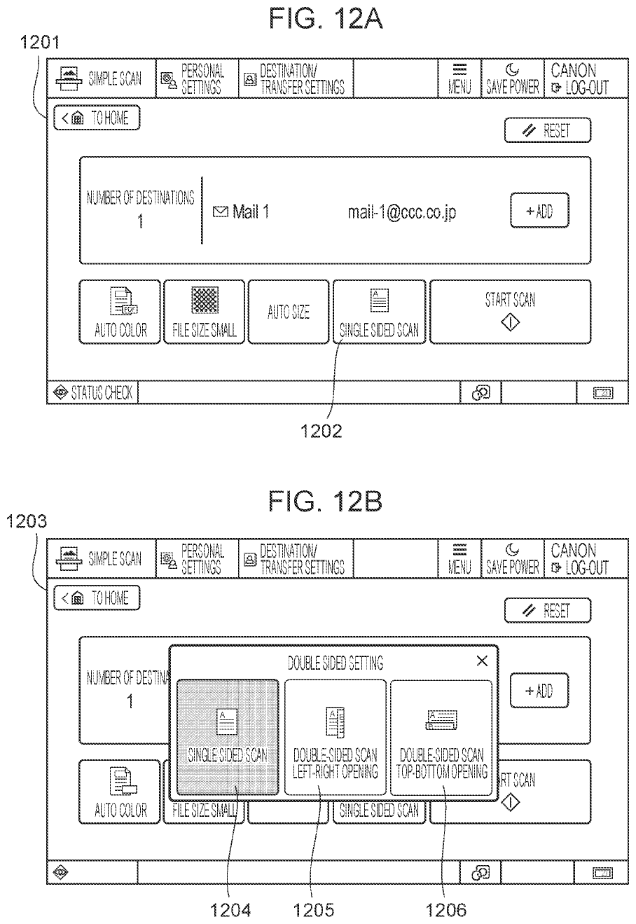

Referring next to FIGS. 12A and 12B, specific control of the image processing apparatus 103 capable of duplex document scanning in the case where at least one of the document-orientation-detection setting flag and the blank-page-removal setting flag is “FALSE” will be described. Specifically, FIGS. 12A and 12B are diagrams illustrating an example of the screen transition of a simple-scan function setting screen displayed on the operating unit 212 of the image processing apparatus 103 capable of duplex document scanning function when at least one of the document-orientation detecting function and the blank-page removing function is disabled (one or both of the functions are disabled) and the simple scan function displayed on the operating unit 212 is activated. The CPU 201 displays a transmission standard screen 1201 shown in FIG. 12A in response to a button for activating the simple scan function being pressed by the user, with the main screen displayed.

FIG. 12A illustrates the transmission standard screen 1201 displayed on the operating unit 212, in which one e-mail address is set. For example, the mail address is the mail address of a user who is currently logging in the image processing apparatus 103. The transmission standard screen 1201 includes a setting key 1202. The setting key 1202 is an area in which the functions set for the simple scan function can be changed and in which the details of the set function are displayed. For the setting key 1202, a “single-sided scan” function, which is a predetermined function to scan one side of a document set in the ADF 225, convert the scanned data into a file, and transmit the file without operating (with disabling) the blank-page removing function and the document-orientation detecting function, is set as the default of a setting for the simple scan function. In other words, the transmission standard screen 1201 displayed in response to activation of the simple scan function displays the “single-sided scan” function as the default in the area of the setting key 1202.

When the CPU 201 detects the setting key 1202 being pressed on the transmission standard screen 1201, the CPU 201 displays a setting selection screen 1203 shown in FIG. 12B. The setting selection screen 1203 displays a “single-sided scan” key 1204, a “double-sided scan, left-right opening” key 1205, and a “double-sided scan, top-bottom opening” key 1206, which accept user-selected functions. The setting selection screen 1203 displays the “single-sided scan” key 1204 highlighted relative to the other functions so as to allow recognizing that the “single-sided scan” key 1204 is enabled. (In other words, the “single-sided scan” function is set as the default of a setting for the single scan function.) When the CPU 201 detects one of the keys 1204 to 1206 being pressed on the setting screen 1203 in FIG. 12B, the CPU 201 sets a function corresponding to one of the enabled keys and displays the transmission standard screen 1201 in which the details of the set function are displayed in the area of the setting key 1202.

The functions represented by the “single-sided scan” key 1204, the “double-sided scan, left-right opening” key 1205, and the “double-sided scan, and the top-bottom opening” key 1206 are the same as the functions represented by the “single-sided scan” key 1105, the “double-sided scan, left-right opening” key 1106, and the “double-sided scan, top-bottom opening” key 1107 shown in FIG. 11B, respectively.

Although an example of the screen of the image processing apparatus 103 capable of duplex document scanning in the case where at least one of the document-orientation-detection setting flag and the blank-page-removal setting flag is “FALSE” has been described with reference to FIGS. 12A and 12B, this is illustrative only. In the case where the duplex document scanning is available, the document-orientation-detection setting flag is “TRUE”, and the blank-page-removal setting flag is “FALSE”, the “auto single-sided/double-sided” key 1102 or 1104 illustrated in FIG. 11A or 11B may be displayed. The “auto single-sided/double-sided” key 1102 or 1104 in this case represents a function to execute the duplex document scanning function, to disable the blank-page removing function, and to enable the document-orientation detecting function in a single step.

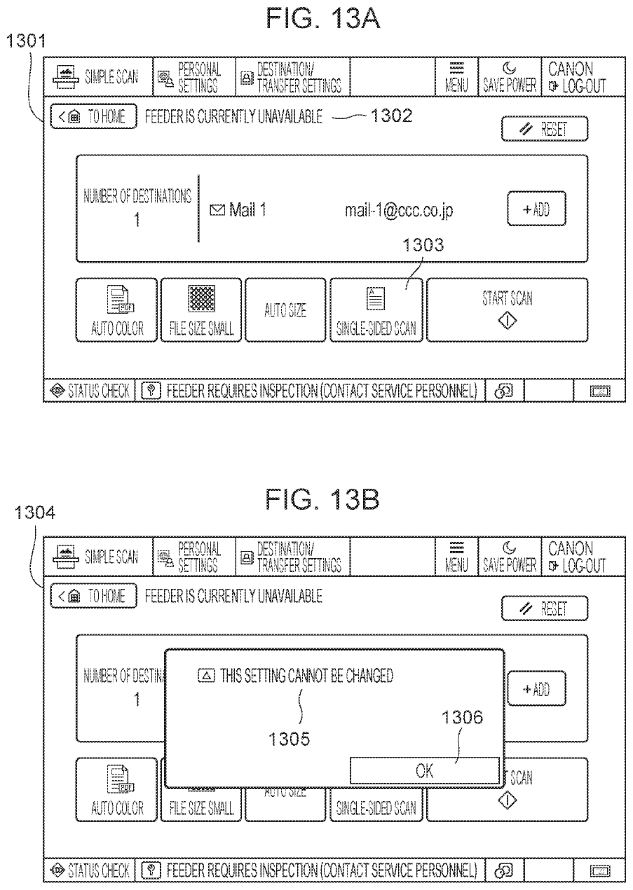

Referring next to FIGS. 13A and 13B, specific control in case of a malfunction of the ADF 225 will be described using a transmission standard screen 1301 displayed on the operating unit 212 as an example. FIGS. 13A and 13B illustrate an example of the screen transition of the transmission standard screen 1301 displayed on the operating unit 212 in the case where a malfunction occurs in the ADF 225 and the simple scan function displayed on the operating unit 212 is activated in the image processing apparatus 103. In other words, in case of a malfunction of the ADF 225, the screens shown in FIGS. 13A and 13B are displayed irrespective of whether the blank-page removing function and the document-orientation detecting function are enabled. The CPU 201 displays the transmission standard screen 1301 shown in FIG. 13A in response to a button for activating the simple scan function being pressed by the user, with the main screen displayed. Conceivable examples of the malfunction of the ADF 225 include a case where the documents on a document feed tray cannot be fed because of the failure of the motor of the mechanism for conveying the documents onto the platen glass and a case where the fed document stops midway in the conveying path.

FIG. 13A illustrates the transmission standard screen 1301 displayed on the operating unit 212, in which one e-mail address is set. For example, the mail address is the mail address of a user who is currently logging in the image processing apparatus 103. Information 1302 is information (a message) for notifying the user that the mechanism for conveying the documents set in the ADF 225 onto the platen glass has a problem, so that the ADF 225 is unusable. The transmission standard screen 1301 includes a setting key 1303. The setting key 1303 is an area for displaying the details of the set functions. For the setting key 1303, a “single-sided scan” function, which is a function to scan the document set on the platen glass, convert the scanned data into a file, and transmit the file without activating (with disabling) the blank-page removing function and the document-orientation detecting function, is set as the default and a fixed value. When the CPU 201 detects the setting key 1303 being pressed on the transmission standard screen 1303, the CPU 201 displays a warning screen 1304 shown in FIG. 13B. The warning screen 1304 displays information 1305 (a message) for notifying the user that the setting for the single scan function cannot be changed. In other words, in the case where the duplex document scanning function is unavailable, and the “single-sided scan” function is selected, the options of the “double-sided scan, left-right opening” key 1205, and the “double-sided scan, top-bottom opening” key 1206 are not displayed. When the CPU 201 detects an “OK” key 1306 being pressed on the warning screen 1304 in FIG. 13B, the screen 1304 returns to the transmission standard screen 1301 shown in FIG. 13A.

The screens shown in FIG. 11A to FIG. 13B are displayed when the “simple scan” function is activated and are not displayed when the “scan and send” function is activated.

The first embodiment has been described as applied to a case in which “auto single-sided/double-sided” is preset as the default for the scanning setting when the document-orientation detecting function and the blank-page removing function are enabled. Alternatively, the default for the scan and send function may be changed for each user. For example, in an environment in which user authentication is required in operating the image processing apparatus 103, which of “auto single-sided/double-sided” and “single-sided scan” is set as the default for a setting for the scan and send function can be set on the operating unit 212, and the set default may be stored in the RAM 208 in association with the authenticated user information.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-053296, filed Mar. 29, 2023, and No. 2023-169331, filed Sep. 29, 2023, which are hereby incorporated by reference herein in their entirety.

What is claimed is:

1. An image processing apparatus having a scanning function to scan image data of a document, the image processing apparatus comprising:
a display control unit configured to display a first setting in a predetermined setting area, the first setting being a setting for executing a first function to execute a function related to the scanning function, the function including at least a function to automatically scan both sides of the document, a function to delete blank data contained in the document, and a function to adjust orientation of the image data contained in the document,
wherein, in response to the predetermined setting area being selected, the display control unit displays a setting screen including a setting different from the first setting, the setting being for executing a function related to the scanning function.

2. The image processing apparatus according to claim 1, wherein the setting screen is a screen that allows selecting the setting for executing the function related to the scanning function, the setting screen containing information on details of the first setting.

3. The image processing apparatus according to claim 1, wherein the display control unit displays the first setting as a default in the predetermined setting area in response to the scanning function being selected on a screen that is displayed first when the image processing apparatus is activated.

4. The image processing apparatus according to claim 1, wherein the display control unit displays the setting screen in which the first setting is enabled.

5. The image processing apparatus according to claim 1, wherein the setting different from the first setting and related the scanning function comprises a second setting for a second function for scanning one side of the document and a third setting for a third function for scanning both sides of the document.

6. The image processing apparatus according to claim 5, wherein, when at least one of the function to delete blank data contained in the document and the function to adjust the orientation of the image data contained in the document is unavailable, not the first setting but the second setting is displayed in the predetermined setting area.

7. The image processing apparatus according to claim 6, wherein, when the second setting displayed in the predetermined setting area is selected, the setting screen displays the second setting and the third setting.

8. The image processing apparatus according to claim 6, wherein the third function includes a function to scan both sides of a document printed on the both sides such that, when the document is reversed in line symmetry about an upper edge or a lower edge of the document, a top and a bottom of the image data are the same on the both sides of the document and a function to scan the both sides of the document printed on the both sides such that, when the document is reversed in line symmetry about a right edge or a left edge of the document, the top and the bottom of the image data are the same on both sides of the document.

9. The image processing apparatus according to claim 6, wherein a case where the function to delete blank data contained in the document is unavailable comprises a case where the function to delete blank data contained in the document is disabled.

10. The image processing apparatus according to claim 6, wherein a case where the function to adjust the orientation of image data contained in the document is unavailable comprises a case where the function to adjust the orientation of the image data contained in the document is disabled.

11. The image processing apparatus according to claim 6, wherein the second setting comprises a setting for enabling the second function and disabling the function to delete blank data contained in the document and the function to adjust the orientation of image data contained in the document.

12. The image processing apparatus according to claim 6, wherein the third setting comprises a setting for enabling the third function and disabling the function to delete blank data contained in the document and the function to adjust the orientation of image data contained in the document.

13. The image processing apparatus according to claim 1, wherein, when the function to automatically scan the both sides of the document is unavailable, the first setting is not displayed in the predetermined setting area, and a fourth setting for executing a fourth function to execute a function to scan image data of the document set on a platen glass of the image processing apparatus is displayed.

14. The image processing apparatus according to claim 13, wherein, when the fourth setting displayed in the predetermined setting area is selected, information indicating that the setting related to the scanning function is unchangeable.

15. The image processing apparatus according to claim 1, wherein a case where the function to automatically scan the both sides of the document is unavailable comprises a case where the image processing apparatus does not include an apparatus for executing the function to automatically scan the both sides of the document.

16. The image processing apparatus according to claim 1, wherein, in a case where the function to automatically scan the both sides of the document is unavailable and the function to delete blank data contained in the document and the function to adjust the orientation of the image data contained in the document are available, the display control unit displays a fifth setting in the predetermined setting area, the fifth setting being a setting for executing a fifth function to execute a function to scan image data of the document set on a platen glass of the image processing apparatus, the function to delete blank data contained in the document, and the function to adjust orientation of the image data contained in the document.

17. The image processing apparatus according to claim 16, wherein, when the fifth setting displayed in the predetermined setting area is selected, the display control unit displays the setting screen containing the fifth setting and a fourth setting for executing a fourth function to execute the function to scan the image data of the document set on the platen glass of the image processing apparatus.

18. The image processing apparatus according to claim 1, further comprising a transmission function to transmit the image data of the document scanned using the scanning function to an external information processing apparatus based on a setting related to the scanning function selected on the setting screen.

19. A method for controlling an image processing apparatus having a scanning function to scan image data of a document, the method comprising:
displaying a first setting in a predetermined setting area, the first setting being a setting for executing a first function to execute a function related to the scanning function, the function including at least a function to automatically scan both sides of the document, a function to delete blank data contained in the document, and a function to adjust orientation of the image data contained in the document; and
in response to the predetermined setting area being selected, displaying a setting screen including a setting different from the first setting, the setting being for executing a function related to the scanning function.

20. A non-transitory computer-readable storage medium storing a program including instructions, which when executed by one or more processors of an image processing apparatus, cause the image processing apparatus to perform operations comprising:
displaying a first setting in a predetermined setting area, the first setting being a setting for executing a first function to execute a function related to the scanning function, the function including at least a function to automatically scan both sides of the document, a function to delete blank data contained in the document, and a function to adjust orientation of the image data contained in the document; and
in response to the predetermined setting area being selected, displaying a setting screen including a setting different from the first setting, the setting being for executing a function related to the scanning function.
